(19) United States
(12) Patent Application Publication
(10) Pub. No.: US 2025/0315461 A1
(43) Pub. Date: Oct. 9, 2025

(54) METHOD FOR PREDICTING TIME SERIES DATA, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Yixiong Xiao, Beijing (CN); Jingbo Zhou, Beijing (CN)

(73) Assignee: BEIJING BAIDU NETCOM SCIENCE TECHNOLOGY CO., LTD., Beijing (CN)

(21) Appl. No.: 19/244,393

(22) Filed: Jun. 20, 2025

(30) Foreign Application Priority Data
Dec. 6, 2024 (CN) 202411798846.4

(51) Int. Cl. G06F 16/334

(52) U.S. Cl. CPC G06F 16/334

(57) ABSTRACT

A method for predicting time series data includes: obtaining time-related data of a target index, in which the time-related data comprises current time series data of the target index; obtaining similar data of the current time series data by performing similarity retrieval in a data set according to the current time series data; and obtaining time series prediction data of the target index by performing time series data prediction based on the time-related data and the similar data.

### CROSS-REFERENCE TO RELATED APPLICATION

This application claims priority to and benefits of Chinese Patent Application No. 202411798846.4, filed on Dec. 6, 2024, the entire content of which is incorporated herein by reference.

### TECHNICAL FIELD

The disclosure relates to the field of computer technology, more particularly, to the field of artificial intelligence such as big data and deep learning, and specifically to a method for predicting time series data, an electronic device and a storage medium.

### BACKGROUND

With the rapid development of big data and artificial intelligence technologies, time series data prediction is playing an increasingly important role in traffic flow prediction, economic and financial analysis, weather forecasting and other fields.

### SUMMARY

The disclosure provides a method and apparatus for predicting time series data, an electronic device and a storage medium.

According to an aspect of embodiments of the disclosure, a method for predicting time series data is provided, including: obtaining time-related data of a target index, wherein the time-related data comprises current time series data of the target index; obtaining similar data of the current time series data by performing similarity retrieval in a data set according to the current time series data; and obtaining time series prediction data of the target index by performing time series data prediction based on the time-related data and the similar data.

According to another aspect of embodiments of the disclosure, an electronic device is provided, including a processor; and a memory communicatively connected to the processor. The memory stores instructions that are executable by the processor, and the instructions are executed by the processor to enable the processor to perform the method according to any of the above embodiments.

According to another aspect of embodiments of the disclosure, a non-transitory computer-readable storage medium storing computer instructions is provided. The computer instructions are configured to cause a computer to perform the method according to any of the above embodiments.

It should be understood that the content described in this section is not intended to identify key or important features of the embodiments of the present disclosure, nor is it intended to limit the scope of the present disclosure. The other features of this disclosure will be easily understood through the following description.

### BRIEF DESCRIPTION OF THE DRAWINGS

The accompanying drawings are used to better understand the present solution and do not constitute a limitation of the present disclosure.

FIG. 1 is a flow chart of a method for predicting time series data provided by an embodiment of the present disclosure;

FIG. 2 is a flow chart of a method for predicting time series data provided by an embodiment of the present disclosure;

FIG. 3 is a flow chart of a method for predicting time series data provided by an embodiment of the present disclosure;

FIG. 4 is a block diagram of an apparatus for predicting time series data provided by an embodiment of the present disclosure;

FIG. 5 is a schematic diagram of an electronic device for implementing the method for predicting time series data according to an embodiment of the present disclosure.

### DETAILED DESCRIPTION

The following is a description of exemplary embodiments of the present disclosure in conjunction with the accompanying drawings, including various details of the embodiments of the present disclosure to facilitate understanding, which should be considered as merely exemplary. Therefore, it should be understood by those skilled in the art that various changes and modifications can be made to the embodiments described herein without departing from the scope and spirit of the present disclosure. Similarly, for the sake of clarity and conciseness, the description of well-known functions and structures is omitted in the following description.

It should be noted that the acquisition, storage, use, and processing of data in the technical solution of this disclosure comply with the relevant provisions of national laws and regulations and do not violate public order and good morals.

The following describes a method and apparatus for predicting time series data, an electronic device and a storage medium of embodiments of the present disclosure with reference to the accompanying drawings.

In some embodiments, current time series data of an index may be used to perform time series data prediction. However, if only the current time series data is used to perform the time series data prediction, the prediction accuracy is not high enough.

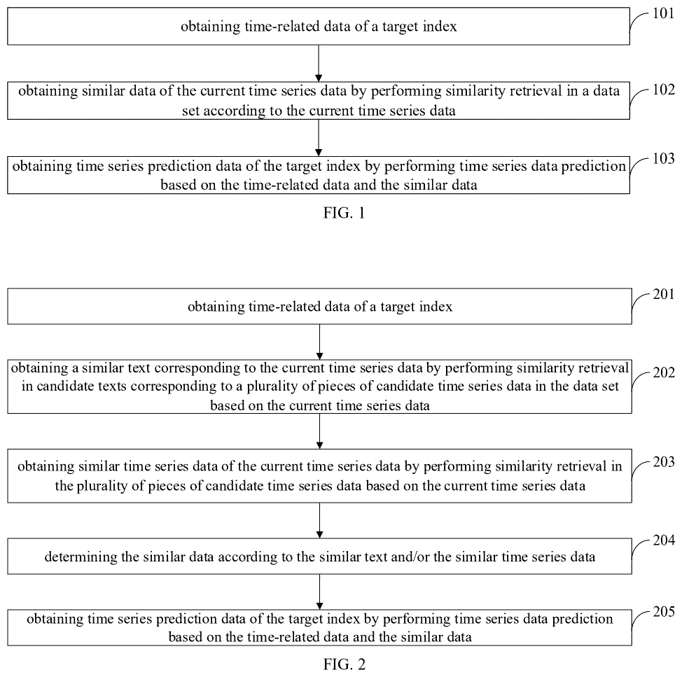

FIG. 1 is a flow chart of a method for predicting time series data provided in an embodiment of the present disclosure.

The method for predicting time series data of embodiments of the present disclosure can be executed by an apparatus for predicting time series data of embodiments of the present disclosure, and the apparatus can be configured in an electronic device.

The electronic device can be any device with computing capabilities, such as a personal computer, a mobile terminal, a server, etc. The mobile terminal can be, for example, a vehicle-mounted device, a mobile phone, a tablet computer, a personal digital assistant, a wearable device, and other hardware devices with various operating systems, touch screens and/or display screens.

As shown in FIG. 1, the method for predicting time series data includes following steps.

Step 101, an electronic device obtains time-related data of a target index.

In some embodiments, the target index may be air temperature, air humidity, traffic flow, or other indexes, which are not limited thereto.

In the present disclosure, the time-related data of the target index may include current time series data of the target index, and may also include a relevant text of the current time series data. The relevant text may be a text related to the current time series data within the time length of the current time series data.

For example, if the target index is temperature, the current time series data is the temperature of the past week, and the relevant text can be the weather news of the past week.

Step 102, the electronic device obtains similar data of the current time series data by performing similarity retrieval in a data set according to the current time series data

The similar data may include a similar text, similar time series data, etc. The similar text may be a text similar to the relevant text of the current time series data, and the similar time series data may be time series data similar to the current time series data. In addition, the similar text may be a text related to the similar time series data within the time length of the similar time series data.

It can be understood that the similar time series data is also time series data of the target index, and the similar text is a text related to the target index.

For example, the current time series data is the temperature of the past week, and the relevant text may be the weather news of the past week. The similar time series data may be the temperature of an earlier week, and the similar text may be the weather news of the earlier week.

It should be noted that the time length of the similar time series data and that of the current time series data may be the same or different, and there is no limitation on this.

In some embodiments, the data set may include paired candidate time series data and candidate texts, and the data set may also include multiple pieces of candidate time series data of multiple indexes and candidate texts corresponding to the multiple pieces of candidate time series data. It should be noted that the multiple indexes here may be indexes of one field or indexes of different fields, and there may be one or more indexes in the same field.

In some embodiments, the similarity retrieval may be performed in the data set based on the current time series data to obtain time series data similar to the current time series data, and the similar data that is similar to the current time series data may be obtained based on the time series data.

Step 103, the electronic device obtains time series prediction data of the target index by performing time series data prediction based on the time-related data and the similar data.

In this disclosure, the time-related data and the similar data can be input into a pre-trained time series prediction model for time series data prediction, and the time series prediction data of the target index is obtained. The time length of the time series prediction data and that of the current time series data can be the same or different, and there is no limitation on this.

For example, the time series prediction model can be a prediction model based on a Transformer structure. The prediction model based on the Transformer structure can effectively capture the global and local dependencies in the time series data through the self-attention mechanism, thereby further improving the accuracy and effect of the prediction.

In some embodiments, the time series data prediction may be performed based on the current time series data and the similar data in the time-related data to obtain the time series prediction data.

In some embodiments, the time-related data may also include the relevant text of the current time series data, and the time series data prediction may be performed based on the current time series data, the relevant text of the current time series data, and the similar data to obtain the time series prediction data.

In embodiments of the present disclosure, by obtaining the time-related data of the target index, the similarity retrieval is performed based on the current time series data of the target index in the time-related data to obtain the similar data, and then the time series data prediction is performed based on the time-related data and the similar data to obtain the time series prediction data. Thus, the similar data of the current time series data is retrieved from the data set through the similarity retrieval, and the similar data is used to assist the time-related data in predicting the time series data, thereby improving the accuracy of the time series data prediction.

FIG. 2 is a flow chart of a method for predicting time series data provided in an embodiment of the present disclosure.

As shown in FIG. 2, the method for predicting time series data includes following steps.

Step 201, an electronic device obtains time-related data of a target index.

In the present disclosure, step 201 can be implemented in a way in any of the embodiments of the present disclosure, which is not described in detail here.

Step 202, the electronic device obtains a similar text corresponding to the current time series data by performing, according to the current time series data, similarity retrieval in candidate texts corresponding to multiple pieces of candidate time series data in the data set.

A paired candidate time series data and candidate text in the data set are data within the same time period.

As a possible implementation, a relevant text of the current time series data can be obtained, a similarity between the relevant text and each candidate text can be calculated, and the similar text can be determined from the candidate texts according to the similarities. For example, a candidate text with the maximum similarity can be determined as the similar text.

Therefore, based on the relevant text of the current time series data, the similar text can be found from the candidate texts in the data set based on the similarity retrieval, thereby improving the accuracy of the similar text.

In addition, the similar text is obtained by performing retrieval based on the relevant text of the current time series data, the similar text is also relevant to the current time series data, so the similar text obtained based on text retrieval can supplement the current time series data.

As another possible implementation, a first Euclidean distance between the current time series data and each piece of candidate time series data can be calculated, and the similar time series data can be determined from the multiple pieces of candidate time series data based on the first Euclidean distance corresponding to each piece of candidate time series data, and then a candidate text corresponding to the similar time series data can be determined as the similar text.

For example, the candidate time series data having a minimum first Euclidean distance with the current time series data may be determined as the similar time series data.

Therefore, based on the Euclidean distance between the current time series data and each piece of candidate time series data in the data set, time series data similar to the current time series data can be retrieved from the data set, and then the candidate text corresponding to the similar time series data can be determined as the similar text, enriching the method of obtaining the similar text.

In addition, since the similar text is a text corresponding to the time series data similar to the current time series data, the similar text is also relevant to the current time series data, so the similar text retrieved based on the Euclidean distance of the time series can supplement the current time series data.

The time length of the current time series data and that of the candidate time series data may be the same or different. Thus, the first time length of the current time series data and the second time length of the candidate time series data can be determined, and the first Euclidean distance between the current time series data and the candidate time series data can be calculated based on the first time length and the second time length. Thus, the calculation of the Euclidean distance between two time series data in different scenarios can be satisfied.

In some embodiments, if the first time length is the same as the second time length, the first Euclidean distance between the current time series data and the candidate time series data is calculated directly based on an index value of the target index at the corresponding time points of the current time series data and the candidate time series data.

In some embodiments, if the first time length is greater than the second time length, multiple first sub-time series data can be intercepted from the current time series data according to the second time length, in which the length of the first sub-time series data is the same as the second time length, and a second Euclidean distance between each piece of first sub-time series data and the candidate time series data is calculated, and then the first Euclidean distance is determined based on the multiple second Euclidean distances. For example, the minimum second Euclidean distance in the multiple second Euclidean distances can be used as the first Euclidean distance between the current time series data and the candidate time series data.

When intercepting the first sub-time series data, the second time length can be used as a window length, the window can be slid on the current time series data, and the time series data in the window can be used as the first sub-time series data, so that multiple pieces of first sub-time series data can be intercepted through the sliding window.

Therefore, when the time length of the current time series data is greater than the time length of the candidate time series data, the current time series data can be intercepted to obtain multiple pieces of time series data with the same time length as the candidate time series data, and the Euclidean distance between the intercepted time series data and the candidate time series data is calculated, and then the Euclidean distance between the current time series data and the candidate time series data is obtained, which meets the requirement for calculating the Euclidean distance between the two time series data in the scenario where the time length of the current time series data is greater than the time length of the candidate time series data.

In some embodiments, if the second time length is greater than the first time length, multiple second sub-time series data are intercepted from the candidate time series data according to the first time length, in which the length of the second sub-time series data is the same as the first time length, and a third Euclidean distances between each piece of second sub-time series data and the candidate time series data is calculated, and then the first Euclidean distance is determined according to the multiple third Euclidean distances. For example, the minimum third Euclidean distance in the multiple third Euclidean distances can be used as the first Euclidean distance between the current time series data and the candidate time series data.

When intercepting the second sub-time series data, the first time length can be used as the window length, the window can be slid on the candidate time series data, and the time series data in the window can be used as the second sub-time series data, so that multiple pieces of second sub-time series data can be intercepted by sliding the window.

Therefore, when the time length of the candidate time series data is greater than the time length of the current time series data, the candidate time series data can be intercepted to obtain multiple pieces of time series data with the same time length as the current time series data, and the Euclidean distance between the intercepted time series data and the current time series data is calculated, and then the Euclidean distance between the current time series data and the candidate time series data is obtained, which meets the requirement for calculating the Euclidean distance between the two time series data in the scenario where the time length of the candidate time series data is greater than the time length of the current time series data.

Step 203, the electronic device obtains similar time series data of the current time series data by performing, according to the current time series data, similarity retrieval in the plurality of pieces of candidate time series data.

As a possible implementation, a first Euclidean distance between the current time series data and each piece of candidate time series data can be calculated, and then the similar time series data can be determined from the multiple pieces of candidate time series data according to the first Euclidean distances corresponding to the multiple pieces of candidate time series data. For example, the candidate time series data with the minimum first Euclidean distance to the current time series data can be used as the similar time series data.

The calculation method of the first Euclidean distance may refer to the method described in the above embodiments, which will not be described in detail here.

Therefore, based on the Euclidean distance between the current time series data and each pieces of candidate time series data in the data set, the time series data similar to the current time series data can be retrieved from the data set through similarity retrieval, thereby improving the accuracy of similar time series data and further improving the accuracy of time series data prediction.

As another possible implementation, a relevant text of the current time series data can be obtained, a similarity between the relevant text and a candidate text corresponding to each piece of candidate time series data can be calculated, and based on the similarities, a similar text can be determined from the candidate texts, and then the candidate time series data corresponding to the similar text can be determined as the similar time series data.

Therefore, based on the relevant text of the current time series data, the similar text can be obtained through similarity retrieval, and then the candidate time series data corresponding to the similar text can be used as the similar time series data of the current time series data, enriching the method of obtaining the similar time series data.

In addition, the similar text is a text similar to the relevant text of the current time series data, thus the candidate time series data corresponding to the similar text is also similar to the current time series data, so the similar time series data can assist the current time series data in time series data prediction.

Step 204, the electronic device determines the similar data according to the similar text and/or the similar time series data.

The similar data may include the similar text, or may include the similar time series data, or may include both the similar text and the similar time series data, and there is no limitation on this.

Since the data set may include candidate time series data of multiple different indexes and their corresponding candidate texts, in order to improve the retrieval efficiency, as a possible implementation, the candidate time series data of the target index can be determined from the data set based on a semantic similarity between the target index and the index name in each piece of candidate time series data in the data set, and then the similar data can be obtained by performing, according to the current time series data, the similarity retrieval on the candidate time series data of the target index and the candidate text corresponding to the candidate time series data of the target index.

In some embodiments, the candidate time series data with semantic similarity greater than a similarity threshold may be determined as the candidate time series data of the target index, thereby screening out the candidate time series data of the target index and its corresponding candidate text from the data set.

The method of performing the similarity retrieval on the candidate time series data of the target index and the candidate text corresponding to the candidate time series data of the target index according to the current time series data can refer to the retrieval method described in the above embodiments, which is not repeated here.

Therefore, based on the semantic similarity between the target index and the index name in the candidate time series data in the data set, the candidate time series data of the target index and its corresponding candidate text can be screened out from the data set, and then the similarity retrieval can be performed on the screened candidate time series data and its corresponding candidate text, thereby narrowing the retrieval scope and improving the retrieval efficiency.

Step 205, the electronic device obtains time series prediction data of the target index by performing time series data prediction based on the time-related data and the similar data.

In this disclosure, a pre-trained time series prediction model can be used to perform the time series data prediction to obtain the time series prediction data of the target index.

For example, if the time series prediction model is trained based on time series data and similar texts of the time series data, the current time series data and the similar text in the similar data can be input into the time series prediction model for prediction to obtain the time series prediction data. Thus, the current time series data can be supplemented with information through the similar text, thereby improving the accuracy of the prediction.

For example, the current time series data is the weather in the past week, and the similar text is the weather news during an earlier time period. These two kinds of information can be used to predict the weather in the next week.

In some embodiments, the time series prediction model can encode the current time series data to obtain a first time series feature, encode the similar text to obtain a first text feature, and fuse the first time series feature with the first text feature to obtain a first fusion feature, and then obtain the time series prediction data by performing time series data prediction according to the first fusion feature. Thus, the features of the two modalities of the current time series data and the similar text are fused, and the time series data prediction is performed based on the fused features, thereby improving the accuracy of the prediction.

For example, a BERT (Bidirectional Encoder Representations from Transformers) encoder may be used to encode the similar text to obtain the first text feature, thereby converting the similar text into a high-dimensional vector representation.

Since the first time series feature and the first text feature are features of different modalities, the first time series feature can be standardized to obtain a first standard feature, the first text feature can be standardized to obtain a second standard feature, and then the first standard feature and the second standard feature can be fused to obtain the first fusion feature. In this way, the features of different modalities can be standardized before being fused, thereby improving the accuracy of the fusion feature.

In some embodiments, if the time series prediction model is trained based on time series data and time series data similar to the time series data, then the current time series data and similar time series data in the similar data can be input into the time series prediction model for prediction to obtain the time series prediction data.

For example, the current time series data is the weather in the past week, and the similar time series data is the weather in an earlier week. These two types of information can be used to predict the weather in the next week.

In some embodiments, the current time series data can be encoded to obtain a first time series feature, the similar time series data can be encoded to obtain a second time series feature, the first time series feature and the second time series feature can be fused, and the time series data prediction can be performed based on the fused features, thereby improving the accuracy of the prediction.

In some embodiments, if the time series prediction model is trained based on time series data and its relevant texts as well as similar texts of the time series data, the current time series data and its relevant text as well as the similar text in the similar data can be input into the time series prediction model for prediction to obtain the time series prediction data.

In some embodiments, if the time series prediction model is trained based on time series data and its relevant texts as well as time series data similar to the time series data, the current time series data and its relevant text as well as the similar time series data in the similar data can be input into the time series prediction model for prediction to obtain the time series prediction data.

For example, the current time series data is the weather of the past week, the relevant text is the weather news of the past week, and the similar time series data is the weather of an earlier week. These three types of information can be used to predict the weather for the next week.

In some embodiments, if the time series prediction model is trained based on time series data and its relevant texts, texts similar to the relevant texts, and time series data similar to the time series data, the current time series data and its relevant text, as well as the similar text in the similar data and the similar time series data can be input into the time series prediction model for prediction to obtain the time series prediction data.

For example, the current time series data is the weather of the past week, the relevant text is the weather news of the past week, the similar time series data is the weather of an earlier week, and the similar text is the weather news of an earlier week. These four types of information can be used to predict the weather for the next week.

In embodiments of the present disclosure, by performing the similarity retrieval in the candidate texts corresponding to the multiple pieces of candidate time series data in the data set according to the current time series data, the similar text is obtained, and by performing the similarity retrieval in the multiple pieces of candidate time series data, the similar time series data is obtained, so that the similar data can be obtained based on the retrieval results of the similarity retrieval, thereby improving the accuracy of the similar data, and then performing time the series data prediction by using the similar data to assist the time-related data, thereby improving the accuracy of the prediction.

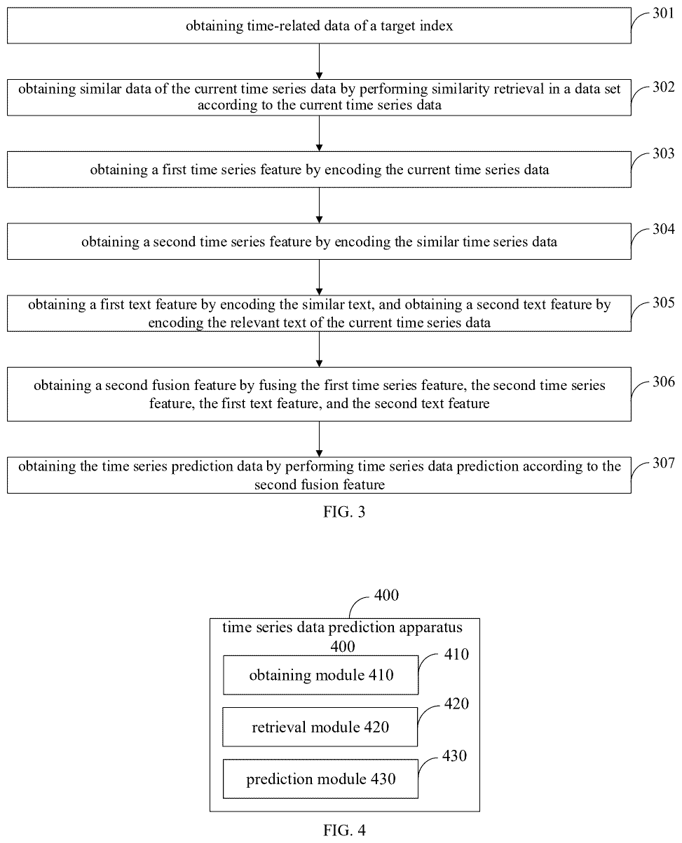

FIG. 3 is a flow chart of a method for predicting time series data provided by an embodiment of the present disclosure.

As shown in FIG. 3, the method for predicting time series data includes the following steps.

Step 301, an electronic device obtains time-related data of a target index.

Step 302, the electronic device obtains similar data of the current time series data by performing similarity retrieval in a data set according to the current time series data

In the present disclosure, step 301-step 302 can be implemented in any way of the embodiments of the present disclosure, which will not be described in detail here.

Step 303, the electronic device obtains a first time series feature by encoding the current time series data.

In some embodiments, the current time series data can be segmented to obtain multiple time series segments, and each time series segment can be encoded to obtain a sub-time series feature. Then, according to a time order between the multiple time series segments, the sub-time series features corresponding to the multiple time series segments can be spliced to obtain the first time series feature.

For example, if the current time series data is the temperature over the past 10 days, the temperature over two consecutive days can be taken as a time series segment, the current time series data can be divided into five time series segments.

It should be noted that the time lengths of the multiple time series segments may be the same or different, and there is no limitation on this.

Therefore, by dividing the current time series data into multiple time series segments for encoding, local and global information can be captured, thereby improving the accuracy of the prediction.

Step 304, the electronic device obtains a second time series feature by encoding the similar time series data.

In some embodiments, the similar time series data may be divided into multiple time series segments, and then the time series segments are encoded, and then the time series features of the multiple time series segments are spliced to obtain the second time series feature.

Step 305, the electronic device obtains a first text feature by encoding the similar text, and obtains a second text feature by encoding the relevant text of the current time series data.

In some embodiments, a BERT encoder may be used to encode the similar text and the relevant texts to obtain the first text feature and the second text feature, thereby converting the similar text and the relevant text into high-dimensional vector representations.

Step 306, the electronic device obtains a second fusion feature by fusing the first time series feature, the second time series feature, the first text feature, and the second text feature.

In some embodiments, the first time series feature, the second time series feature, the first text feature, and the second text feature may standardized respectively to obtain corresponding standard features, and then these standard features may be fused to obtain the second fused feature.

The dimensions of the features of different modalities may be different, thus the dimensions of the features can be made consistent through a padding operation and then fused to obtain the second fused feature.

Step 307, the electronic device obtains the time series prediction data by performing time series data prediction according to the second fusion feature.

In some embodiments, feature extraction may be performed on the second fused feature, and then the extracted feature may be decoded to obtain the time series prediction data.

In embodiments of the present disclosure, the similar time series data and the similar text can be used to assist the current time series data and the relevant text in time series data prediction, so that similar time series data and the similar text can be fully utilized to improve the accuracy and comprehensiveness of the time series data prediction. In addition, the current time series data and the similar time series data are respectively encoded to obtain features, and the similar text and the relevant text are encoded to obtain features, and these features are fused, and prediction is performed based on the fused features, which can improve the accuracy of the prediction.

The method for predicting time series data of the embodiment of the present disclosure can be applied to a variety of scenarios, and is also applicable to fields that need to handle complex time series prediction tasks. For example, the fields and scenarios can be as follows.

Weather prediction: By combining time series data of weather indexes and text data such as weather news, more accurate weather prediction can be achieved, making it easier for people to plan daily travel and life.

Traffic flow prediction: By combining historical traffic data with relevant text information, such as traffic news and incident reports, more accurate traffic flow prediction can be achieved to optimize traffic management and scheduling.

Economic and financial analysis: Using time series data of economic indexes and text data such as financial news and policy documents can improve the ability to predict market changes.

Social welfare project evaluation: Combining the time series data of social welfare projects with related news can predict project effects and impacts and optimize resource allocation.

In order to implement the above embodiments, the present disclosure also provides an apparatus for predicting time series data. FIG. 4 is a block diagram of an apparatus for predicting time series data provided by an embodiment of the present disclosure.

As shown in FIG. 4, the apparatus 400 for predicting time series data includes: an obtaining module 410, a retrieval module 420, and a prediction module 430.

The obtaining module 410 is configured to obtain time-related data of a target index, wherein the time-related data comprises current time series data of the target index.

The retrieval module 420 is configured to obtain similar data of the current time series data by performing similarity retrieval in a data set according to the current time series data.

The prediction module 430 is configured to obtain time series prediction data of the target index by performing time series data prediction based on the time-related data and the similar data.

In some embodiments, the retrieval module 420 is configured to: obtain a similar text corresponding to the current time series data by performing, according to the current time series data, similarity retrieval in candidate texts corresponding to a plurality of pieces of candidate time series data in the data set; obtain similar time series data of the current time series data by performing, according to the current time series data, similarity retrieval in the plurality of pieces of candidate time series data; and determine the similar data according to the similar text and/or the similar time series data.

In some embodiments, the retrieval module 420 is configured to: obtain a relevant text of the current time series data; determine a similarity between the relevant text and a candidate text corresponding to each piece of candidate time series data; and determine the similar text from the candidate texts according to the similarity.

In some embodiments, the retrieval module 420 is configured to: determine a first Euclidean distance between the current time series data and each piece of candidate time series data; determine the similar time series data from the plurality of pieces of candidate time series data according to the first Euclidean distance corresponding to each piece of candidate time series data; and determine a candidate text corresponding to the similar time series data as the similar text.

In some embodiments, the retrieval module 420 is configured to: determine a first Euclidean distance between the current time series data and each piece of candidate time series data; and determine the similar time series data from the plurality of pieces of candidate time series data according to the first Euclidean distance corresponding to each piece of candidate time series data.

In some embodiments, the retrieval module 420 is configured to: determine a first time length of the current time series data and a second time length of the candidate time series data; and determine the first Euclidean distance between the current time series data and the candidate time series data according to the first time length and the second time length.

In some embodiments, the retrieval module 420 is configured to: in response to the first time length being greater than the second time length, intercept a plurality of pieces of first sub-time series data from the current time series data according to the second time length, wherein a length of the first sub-time series data is the same as the second time length; determine a plurality of second Euclidean distances between the plurality of pieces of first sub-time series data and the candidate time series data; and determine the first Euclidean distance according to the plurality of second Euclidean distances.

In some embodiments, the retrieval module 420 is configured to: in response to the second time length being greater than the first time length, intercept a plurality of pieces of second sub-time series data from the candidate time series data according to the first time length, wherein a length of the second sub-time series data is the same as the first time length; determine a plurality of third Euclidean distances between the plurality of pieces of second sub-time series data and the candidate time series data; and determine the first Euclidean distance according to the plurality of the third Euclidean distances.

In some embodiments, the retrieval module 420 is configured to: obtain a relevant text of the current time series data; determine a similarity between the relevant text and a candidate text corresponding to each piece of candidate time series data; determine a similar text from the candidate texts according to the similarity; determine candidate time series data corresponding to the similar text as the similar time series data.

In some embodiments, the retrieval module 420 is configured to: determine candidate time series data of the target index from the data set according to a semantic similarity between the target index and an index name in each piece of candidate time series data in the data set; obtain the similar data by performing, according to the current time series data, the similarity retrieval on the candidate time series data of the target index and a candidate text corresponding to the candidate time series data of the target index.

In some embodiments, the similar data comprises a similar text. The prediction module 430 is configured to: obtain a first time series feature by encoding the current time series data; obtain a first text feature by encoding the similar text; obtain a first fusion feature by fusing the first time series feature and the first text feature; and obtain the time series prediction data by performing time series data prediction according to the first fusion feature.

In some embodiments, the prediction module 430 is configured to: obtain a first standard feature by standardizing the first time series feature; obtain a second standard feature by standardizing the first text feature; and obtain the first fusion feature by fusing the first standard feature and the second standard feature.

In some embodiments, the time-related data further comprises a relevant text of the current time series data, the similar data comprises similar time series data and a similar text, and the prediction module 430 is configured to: obtain a first time series feature by encoding the current time series data; obtain a second time series feature by encoding the similar time series data; obtain a first text feature by encoding the similar text, and obtain a second text feature by encoding the relevant text of the current time series data; obtain a second fusion feature by fusing the first time series feature, the second time series feature, the first text feature, and the second text feature; and obtaining the time series prediction data by performing time series data prediction according to the second fusion feature.

In some embodiments, the prediction module 430 is configured to: obtain a plurality of time series segments by segmenting the current time series data; obtain a sub-time series feature by encoding each of the plurality of time series segments; obtain the first time series feature by splicing the sub-time series features respectively corresponding to the plurality of time series segments according to a time order between the plurality of time series segments.

It should be noted that the explanation of the aforementioned method for predicting time series data embodiments is also applicable to the apparatus for predicting time series data of this embodiment, and it will not be repeated here.

In embodiments of the present disclosure, by obtaining the time-related data of the target index, the similarity retrieval is performed based on the current time series data of the target index in the time-related data to obtain the similar data, and then the time series data prediction is performed based on the time-related data and the similar data to obtain the time series prediction data. Thus, the similar data of the current time series data is retrieved from the data set through the similarity retrieval, and the similar data is used to assist the time-related data in the time series data prediction, thereby improving the accuracy of the time series data prediction.

According to an embodiment of the present disclosure, the present disclosure also provides an electronic device, a readable storage medium and a computer program product.

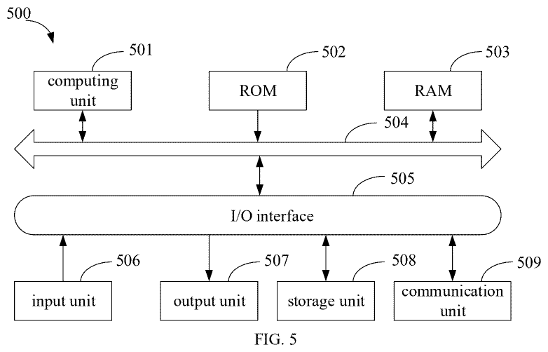

FIG. 5 shows a schematic diagram of an example electronic device 500 that can be used to implement an embodiment of the present disclosure. The electronic device is intended to represent various forms of digital computers, such as laptop computers, desktop computers, workbenches, personal digital assistants, servers, blade servers, mainframe computers, and other suitable computers. The electronic device can also represent various forms of mobile devices, such as personal digital processing, cellular phones, smart phones, wearable devices, and other similar computing devices. The components shown herein, their connections and relationships, and their functions are merely examples, and are not intended to limit the implementation of the present disclosure described herein and/or required.

As shown in FIG. 5, the device 500 includes a computing unit 501, which can perform various appropriate actions and processes according to a computer program stored in a ROM (Read-Only Memory) 502 or a computer program loaded from a storage unit 508 into a RAM (Random Access Memory) 503. In the RAM 503, various programs and data required for the operation of the device 500 can also be stored. The computing unit 501, the ROM 502, and the RAM 503 are connected to each other via a bus 504. An I/O (Input/Output) interface 505 is also connected to the bus 504.

A plurality of components in the device 500 are connected to the I/O interface 505, including: an input unit 506, such as a keyboard, a mouse, etc.; an output unit 507, such as various types of displays, speakers, etc.; a storage unit 508, such as a disk, an optical disk, etc.; and a communication unit 509, such as a network card, a modem, a wireless communication transceiver, etc. The communication unit 509 allows the device 500 to exchange information/data with other devices through a computer network such as the Internet and/or various telecommunication networks.

The computing unit 501 may be a variety of general and/or special processing components with processing and computing capabilities. Some examples of the computing unit 501 include, but are not limited to, a CPU (Central Processing Unit), a GPU (Graphic Processing Units), various dedicated AI (Artificial Intelligence) computing chips, various computing units running machine learning model algorithms, a DSP (Digital Signal Processor), and any appropriate processor, controller, microcontroller, etc. The computing unit 501 performs the various methods and processes described above, such as the method for predicting time series data. For example, in some embodiments, the method for predicting time series data may be implemented as a computer software program, which is tangibly contained in a machine-readable medium, such as a storage unit 508. In some embodiments, part or all of the computer program may be loaded and/or installed on the device 500 via the ROM 502 and/or the communication unit 509. When the computer program is loaded into the RAM 503 and executed by the computing unit 501, one or more steps of the method for predicting time series data described above may be performed. Alternatively, in other embodiments, the computing unit 501 may be configured to execute the method for predicting time series data in any other appropriate manner (e.g., by means of firmware).

Various embodiments of the systems and techniques described above herein may be implemented in digital electronic circuit systems, integrated circuit systems, FPGAs (Field Programmable Gate Arrays), ASICs (Application-Specific Integrated Circuits), ASSPs (Application Specific Standard Products), SOCs (System On Chips), CPLDs (Complex Programmable Logic Devices), computer hardware, firmware, software, and/or combinations thereof. These various embodiments may include: being implemented in one or more computer programs that may be executed and/or interpreted on a programmable system including at least one programmable processor that may be a dedicated or general-purpose programmable processor that may receive data and instructions from a storage system, at least one input device, and at least one output device, and transmit data and instructions to the storage system, the at least one input device, and the at least one output device.

The program codes for implementing the method of the present disclosure can be written in any combination of one or more programming languages. These program codes can be provided to a processor or controller of a general-purpose computer, a special-purpose computer, or other programmable data processing device, so that the program codes, when executed by the processor or controller, cause the functions/operations specified in the flow chart and/or block diagram to be implemented. The program codes can be executed entirely on the machine, partially on the machine, partially on the machine and partially on a remote machine as a stand-alone software package, or entirely on a remote machine or server.

In the context of the present disclosure, a machine-readable medium may be a tangible medium that may contain or store a program for use by or in conjunction with an instruction execution system, device, or equipment. A machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media may include electrical connections based on one or more lines, portable computer disks, hard disks, RAM, ROM, EPROM (Electrically Programmable Read-Only-Memory) or flash memory, optical fiber, CD-ROM (Compact Disc Read-Only Memory), optical storage devices, magnetic storage devices, or any suitable combination of the foregoing.

To provide interaction with a user, the systems and techniques described herein can be implemented on a computer having: a display device (e.g., a CRT (Cathode-Ray Tube) or LCD (Liquid Crystal Display) monitor) for displaying information to the user; and a keyboard and pointing device (e.g., a mouse or trackball) through which the user can provide input to the computer. Other types of devices can also be used to provide interaction with the user. For example, the feedback provided to the user can be any form of sensory feedback (e.g., visual feedback, auditory feedback, or tactile feedback); and input from the user can be received in any form (including acoustic input, voice input, or tactile input).

The systems and techniques described herein may be implemented in a computing system that includes backend components (e.g., as a data server), or a computing system that includes middleware components (e.g., an application server), or a computing system that includes frontend components (e.g., a user computer with a graphical user interface or a web browser through which a user can interact with implementations of the systems and techniques described herein), or a computing system that includes any combination of such backend components, middleware components, or frontend components. The components of the system may be interconnected by any form or medium of digital data communication (e.g., a communication network). Examples of communication networks include: LAN (Local Area Network), WAN (Wide Area Network), the Internet, and blockchain networks.

A computer system may include a client and a server. The client and the server are generally remote from each other and usually interact through a communication network. The relationship between the client and the server is generated by computer programs running on the corresponding computers and having a client-server relationship with each other. The server may be a cloud server, also known as a cloud computing server or a cloud host, which is a host product in the cloud computing service system to solve the defects of difficult management and weak business scalability in traditional physical hosts and VPS (Virtual Private Server) services. The server may also be a server of a distributed system, or a server combined with a blockchain.

According to an embodiment of the present disclosure, the present disclosure also provides a computer program product. When an instruction in the computer program product is executed by a processor, the method for predicting time series data proposed in the above embodiments of the present disclosure is performed.

It should be understood that the various forms of processes shown above can be reordered, added or deleted. For example, the steps recorded in this disclosure can be executed in parallel, sequentially or in different orders, as long as the expected results of the technical solution disclosed in this disclosure can be achieved, and this document is not limited here.

The above specific implementations do not constitute a limitation on the protection scope of this disclosure. It should be understood by those skilled in the art that various modifications, combinations, sub-combinations and substitutions can be made according to design requirements and other factors. Any modifications, equivalent substitutions and improvements made within the spirit and principles of this disclosure should be included in the protection scope of this disclosure.

1. A method for predicting time series data, performed by an electronic device, comprising:
obtaining time-related data of a target index, wherein the time-related data comprises current time series data of the target index;
obtaining similar data of the current time series data by performing similarity retrieval in a data set according to the current time series data; and
obtaining time series prediction data of the target index by performing time series data prediction based on the time-related data and the similar data.

2. The method according to claim 1, wherein obtaining the similar data of the current time series data by performing the similarity retrieval in the data set according to the current time series data comprises:
obtaining a similar text corresponding to the current time series data by performing similarity retrieval in candidate texts corresponding to a plurality of pieces of candidate time series data in the data set based on the current time series data;
obtaining similar time series data of the current time series data by performing similarity retrieval in the plurality of pieces of candidate time series data based on the current time series data; and
determining the similar data according to at least one of the similar text or the similar time series data.

3. The method according to claim 2, wherein obtaining the similar text corresponding to the current time series data by performing the similarity retrieval in candidate texts corresponding to the plurality of pieces of candidate time series data in the data set based on the current time series data comprises:
obtaining a relevant text of the current time series data;
determining a similarity between the relevant text and a candidate text corresponding to each piece of candidate time series data; and
determining the similar text from the candidate texts according to the similarity.

4. The method according to claim 2, wherein obtaining the similar text corresponding to the current time series data by performing the similarity retrieval in candidate texts corresponding to the plurality of pieces of candidate time series data in the data set based on the current time series data comprises:
determining a first Euclidean distance between the current time series data and each piece of candidate time series data;
determining the similar time series data from the plurality of pieces of candidate time series data according to the first Euclidean distance corresponding to each piece of candidate time series data; and
determining a candidate text corresponding to the similar time series data as the similar text.

5. The method according to claim 2, wherein obtaining similar time series data of the current time series data by performing the similarity retrieval in the plurality of pieces of candidate time series data based on the current time series data comprises:
determining a first Euclidean distance between the current time series data and each piece of candidate time series data; and
determining the similar time series data from the plurality of pieces of candidate time series data according to the first Euclidean distance corresponding to each piece of candidate time series data.

6. The method according to claim 4, wherein determining the first Euclidean distance between the current time series data and each piece of candidate time series data comprises:
determining a first time length of the current time series data and a second time length of the candidate time series data; and
determining the first Euclidean distance between the current time series data and the candidate time series data according to the first time length and the second time length.

7. The method according to claim 6, wherein determining the first Euclidean distance between the current time series data and the candidate time series data according to the first time length and the second time length comprises:
in response to the first time length being greater than the second time length, intercepting a plurality of pieces of first sub-time series data from the current time series data according to the second time length, wherein a length of the first sub-time series data is the same as the second time length;
determining a plurality of second Euclidean distances between the plurality of pieces of first sub-time series data and the candidate time series data; and
determining the first Euclidean distance according to the plurality of second Euclidean distances.

8. The method according to claim 6, wherein determining the first Euclidean distance between the current time series data and the candidate time series data according to the first time length and the second time length comprises:
in response to the second time length being greater than the first time length, intercepting a plurality of pieces of second sub-time series data from the candidate time series data according to the first time length, wherein a length of the second sub-time series data is the same as the first time length;
determining a plurality of third Euclidean distances between the plurality of pieces of second sub-time series data and the candidate time series data; and
determining the first Euclidean distance according to the plurality of the third Euclidean distances.

9. The method according to claim 2, wherein obtaining similar time series data of the current time series data by performing the similarity retrieval in the plurality of pieces of candidate time series data based on the current time series data comprises:
obtaining a relevant text of the current time series data;
determining a similarity between the relevant text and a candidate text corresponding to each piece of candidate time series data;
determining a similar text from the candidate texts according to the similarity; and
determining candidate time series data corresponding to the similar text as the similar time series data.

10. The method according to claim 1, wherein obtaining similar data of the current time series data by performing similarity retrieval in the data set according to the current time series data comprises:
determining candidate time series data of the target index from the data set according to a semantic similarity between the target index and an index name in each piece of candidate time series data in the data set; and
obtaining the similar data by performing, according to the current time series data, the similarity retrieval on the candidate time series data of the target index and a candidate text corresponding to the candidate time series data of the target index.

11. The method according to claim 1, wherein the similar data comprises a similar text, and obtaining time series prediction data of the target index by performing time series data prediction based on the time-related data and the similar data comprises:
obtaining a first time series feature by encoding the current time series data;
obtaining a first text feature by encoding the similar text;
obtaining a first fusion feature by fusing the first time series feature and the first text feature; and
obtaining the time series prediction data by performing time series data prediction according to the first fusion feature.

12. The method according to claim 11, wherein obtaining the first fusion feature by fusing the first time series feature and the first text feature comprises:
obtaining a first standard feature by standardizing the first time series feature;
obtaining a second standard feature by standardizing the first text feature; and
obtaining the first fusion feature by fusing the first standard feature and the second standard feature.

13. The method according to claim 1, wherein the time-related data further comprises a relevant text of the current time series data, the similar data comprises similar time series data and a similar text, and obtaining time series prediction data of the target index by performing time series data prediction based on the time-related data and the similar data comprises:
obtaining a first time series feature by encoding the current time series data;
obtaining a second time series feature by encoding the similar time series data;
obtaining a first text feature by encoding the similar text, and obtaining a second text feature by encoding the relevant text of the current time series data;
obtaining a second fusion feature by fusing the first time series feature, the second time series feature, the first text feature, and the second text feature; and
obtaining the time series prediction data by performing time series data prediction according to the second fusion feature.

14. The method according to claim 11, wherein obtaining the first time series feature by encoding the current time series data comprises:
obtaining a plurality of time series segments by segmenting the current time series data;
obtaining a sub-time series feature by encoding each of the plurality of time series segments;
obtaining the first time series feature by splicing sub-time series features respectively corresponding to the plurality of time series segments according to a time order between the plurality of time series segments.

15. An electronic device, comprising:
a processor; and
a memory storing instructions executable by the processor;
wherein the processor is configured to:
obtain time-related data of a target index, wherein the time-related data comprises current time series data of the target index;
obtain similar data of the current time series data by performing similarity retrieval in a data set according to the current time series data; and
obtain time series prediction data of the target index by performing time series data prediction based on the time-related data and the similar data.

16. The electronic device according to claim 15, wherein the processor is configured to:
obtain a similar text corresponding to the current time series data by performing similarity retrieval in candidate texts corresponding to a plurality of pieces of candidate time series data in the data set based on the current time series data;
obtain similar time series data of the current time series data by performing similarity retrieval in the plurality of pieces of candidate time series data based on the current time series data; and
determine the similar data according to at least one of the similar text or the similar time series data.

17. The electronic device according to claim 16, wherein the processor is configured to:
obtain a relevant text of the current time series data;
determine a similarity between the relevant text and a candidate text corresponding to each piece of candidate time series data; and
determine the similar text from the candidate texts according to the similarity.

18. The electronic device according to claim 16, wherein the processor is configured to:
determine a first Euclidean distance between the current time series data and each piece of candidate time series data;
determine the similar time series data from the plurality of pieces of candidate time series data according to the first Euclidean distance corresponding to each piece of candidate time series data; and
determine a candidate text corresponding to the similar time series data as the similar text.

19. The electronic device according to claim 16, wherein the processor is configured to:
determine a first Euclidean distance between the current time series data and each piece of candidate time series data; and
determine the similar time series data from the plurality of pieces of candidate time series data according to the first Euclidean distance corresponding to each piece of candidate time series data.

20. A non-transitory computer-readable storage medium storing computer instructions, wherein the computer instructions are configured to cause a computer to perform a method for predicting time series data, the method comprising:
obtaining time-related data of a target index, wherein the time-related data comprises current time series data of the target index;
obtaining similar data of the current time series data by performing similarity retrieval in a data set according to the current time series data; and
obtaining time series prediction data of the target index by performing time series data prediction based on the time-related data and the similar data.
